(19) United States
(12) Patent Application Publication
(10) Pub. No.: US 2008/0277462 A1
(43) Pub. Date: Nov. 13, 2008

(54) CARTON AND CORRUGATED BOARD WITH VAPOR LINER

(75) Inventors: Patrick M. Smorch, Sugar Hill, GA (US); Chester D.L. Garner, Richmond, IN (US); Edward M. Gallegos, Suwanee, GA (US)

Correspondence Address: PATENT GROUP GA030-43;GEORGIA-PACIFIC LLC, 133 PEACHTREE STREET, N.E., ATLANTA, GA, 30303-1847, US

(73) Assignee: Georgia-Pacific Corrugated LLC, Atlanta, GA (US)

(21) Appl. No.: 12/181,391

(22) Filed: Jul. 29, 2008

Related U.S. Application Data
(63) Continuation of application No. 11/015,063, filed on Dec. 17, 2004, now abandoned.
(60) Provisional application No. 60/531,676, filed on Dec. 23, 2003.

(51) Int. Cl. B65D 17/00; B65D 5/00; B32B 3/28

(52) U.S. Cl. 229/229; 229/122; 428/186

(57) ABSTRACT

A click-lock re-closable carton is provided that may be simply and securely re-closed. According to one embodiment, the click-lock re-closable carton includes a pair of opposing side panels, a back panel joined to the side panels, a cover pivotally attached to the back panel having a pair of opposing side flanges, and a pair of locking tabs. The locking tabs may be on opposite side panels of the carton and may be offset from one another with respect to the back panel. The carton may be formed from a blank made of low moisture vapor transmission rate corrugated board. One liner face of the corrugated board may include a moisture-resistant extrudate partially absorbed into a first side of a fiberboard substrate, which is bonded to the microflute tips of the corrugated board.

This application is a continuation of U.S. patent application Ser. No. 11/015,063, of the same title, filed Dec. 17, 2004, which claims priority to U.S. Provisional Patent Application Ser. No. 60/531,676, filed Dec. 23, 2003, the disclosures of which are each incorporated herein by reference.

### TECHNICAL FIELD

This invention relates generally to a carton made from corrugated board with a vapor liner. More particularly, the invention relates to a re-closable click-lock carton and low moisture vapor transmission rate corrugated boards for forming such cartons. It also relates to low moisture vapor transmission rate corrugated boards for other uses, and to methods for forming such cartons.

### BACKGROUND

Different types of cartons exist for a variety of different products and purposes. Cartons having low moisture vapor transmission rates are known for storing moisture-sensitive products, such as food items and dry products such as powder. Conventional containers for moisture-sensitive items are made from an outer fiberboard carton that includes a vapor barrier, and a separate fiberboard liner that fits within the outer carton. Often, the outer fiberboard carton is made from solid fiberboard that includes a vapor barrier, such as oriented polypropylene laminated to it, or a barrier coating applied by a rotogravure press. The separate inner liner is made from corrugated fiberboard.

U.S. Pat. No. 5,515,996 issued to Stone discloses a reclosable container that includes an outer carton 10 and a liner 24 snugly fit within the outer carton. The liner and carton of Stone '996 are formed from separate blanks, which are adhered to one another and assembled to form the container. Conventional containers such as these are expensive due, in large part, to the use of separate boards as well as to the assembly costs of manufacturing and combining the two boards. In addition, material losses occur with the manufacture of these containers from independent blanks, because stamping each blank from a fiberboard sheet results in discarded sheet material. Such losses are compounded with the use of multiple blanks from multiple sheets.

Conventional containers also exist that are formed from an outer carton and a liner, which are combined in a single unitary blank. U.S. Pat. No. 5,314,114, which is also issued to Stone, discloses such a container. As shown in FIGS. 2 and 3 of Stone '114, a single blank 30 includes liner panels 38, 40 and 42 connected to and aligned with carton panels 32, 34, 36 and 38. The carton panels are folded to form the carton sidewalls and the liner panels are folded inside the carton panels. Since the liner panels are aligned with the carton panels in a unitary blank, the blank is relatively long and is therefore difficult to nest within a fiberboard sheet. In addition, the configuration of the unitary blank causes a large amount of excess fiberboard material to be wasted.

Conventional cartons for moisture-sensitive items include re-closable cartons, such as laundry detergent cartons. Conventional re-closable moisture-protected cartons either lack locking mechanisms entirely for securing the cover in a closed position, or lack locking mechanisms that securely and easily re-close cartons. As such, the moisture vapor protection afforded from such conventional cartons is compromised when the cartons are not securely re-closed.

Low moisture vapor transmission rate (MVTR) corrugated fiberboard is used to make moisture-protected cartons, as well as for other uses. For example, U.S. Pat. No. 5,772,819 to Olvey discloses a composite of paperboard and plastic film that is formed by extruding a molten polymer between a paper web and a film. As shown in FIG. 1 of Olvey, a primer is applied to paper material at primer application station 12a prior to applying an extruded polymer to the paper using extruder 15. Plastic film from material roll 16 is combined with the paper via extrusion lamination. The composite paper sheet is eventually bonded to the flutes of a single face corrugated board via a corrugator. As also shown in FIG. 1 of Olvey, such an operation includes heating the paper sheet and a single face corrugated board, and then bonding them together in a hot plate section 29 of the corrugator.

Such a three layer composite adds expense and complexity to the process, and therefore to the fiberboard produced. For instance, the cost of the film, which acts as the moisture vapor barrier, can be high. Further, expenses incurred from the additional processing and equipment required to form the three layer composite structure add cost to the finished product.

As discussed above, the paper sheet that includes the plastic film as the moisture vapor barrier passes through a corrugator for bonding the paper sheet to the flutes of a microflute material. The paper sheet is typically printed prior to being processed through the corrugator. The process temperatures in the corrugator increase the temperature of the paper sheet as it passes through the corrugator causing the temperature to exceed the melting point of most plastic films. As a result, the film softens during processing. This causes scuffing or marring of the printed surface during processing, which increases the reject rate and reduces the overall quality of the corrugated fiberboard.

Accordingly, a need exists for an improved low moisture vapor transmission rate carton. In addition, a need exists for a high-strength low moisture vapor transmission rate board for forming such cartons and for other uses.

### SUMMARY

In order to overcome the above-described deficiencies and other shortcomings that will become apparent when reading this specification, aspects of the present invention provide a low MVTR carton and a low MVTR corrugated board. A low MVTR corrugated board according to one embodiment includes a first board, a microflute board attached to a first side of the first board and a second board attached to the microflute board second side. The second board includes a moisture-resistant extrudate that is comprised of a polyolefin, preferably a polyolefin that includes a substantial percentage of high density polyethylene (HDPE) partially absorbed into a first side of the fiberboard substrate. Alternatively, both the first board and the second board may include a moisture-resistant extrudate that is preferably comprised of a substantial percentage of HDPE partially absorbed into one side of the fiberboard substrate. Where polyethylene is used, the board incorporating the moisture vapor barrier is preferably bonded to the microflute board via a cold set adhesive and the microflute and board are bonded using a cold lamination process. Where a moisture resistant extrudate having a higher melt temperature, such as PET, is used, the board may be bonded to the microflute board via a standard starch bond, and the microflute and board are bonded in a standard corrugator. Aspects of the invention further include methods for forming a low MVTR corrugated board. According to an embodiment of the invention, a low MVTR carton is formed from a low MVTR corrugated board.

Aspects of the invention also include a click-lock re-closable carton that may be simply and securely re-closed. According to one embodiment, the click-lock re-closable carton includes a pair of opposing side panels, a back panel joined to the side panels, a cover pivotally attached to the back panel having a pair of opposing side flanges, and a pair of locking tabs. A first one of the locking tabs is foldably attached to a first one of the side panels, and a second one of the locking tabs is foldably attached to a second one of the side panels. According to one aspect of the invention, the first locking tab extends a first distance from the back panel and the second locking tab extends a second distance from the back panel, which is greater than the first distance. As such, the locking tabs are offset from one another with respect to the back panel. Other features and advantages of various aspects of the invention will become apparent with reference to the following detailed description and figures.

### BRIEF DESCRIPTION OF THE DRAWINGS

The invention will be described in detail in the following description of preferred embodiments with reference to the following figures in which like reference numbers refer to like parts and wherein:

FIG. 1 is a perspective view of a click-lock carton according to an embodiment of the invention shown in an unopened configuration but with the tear strip partially removed;

FIG. 2 is perspective view of the carton of FIG. 1 shown in a partially opened configuration;

FIG. 3 is a top view, partially in perspective, of the carton of FIG. 1 shown in a fully opened configuration;

FIG. 4A is a cross-sectional view of a portion of the carton taken along line B-B of FIG. 1 through a locking tab of the carton;

FIG. 4B is a cross-sectional view similar to the view in FIG. 4A of a portion of another embodiment of the carton;

FIG. 5 is a plan view of a carton blank for the carton of FIG. 1;

FIG. 6 is a perspective view of another embodiment of the carton shown in an opened configuration;

FIG. 7 is a top view, partially in perspective, of the carton of FIG. 6 shown in an opened configuration;

FIG. 8 is a plan view of a carton blank for the carton of FIG. 6;

FIG. 9 is a cross-sectional view of a low MVTR board according to an embodiment of the invention;

FIG. 10 is a cross-sectional view of a low MVTR board according to yet another embodiment of the invention;

FIG. 11 is a flow chart illustrating a method for forming the low MVTR board of FIG. 9;

FIG. 12 is a cross-sectional view of a low MVTR board according to still another embodiment of the invention;

FIG. 13 is a schematic drawing showing a portion of a process for forming the low MVTR board of FIG. 12; and

FIG. 14 is a flow chart illustrating a method for forming the low MVTR board of FIG. 13.

### DETAILED DESCRIPTION OF THE PREFERRED EMBODIMENTS

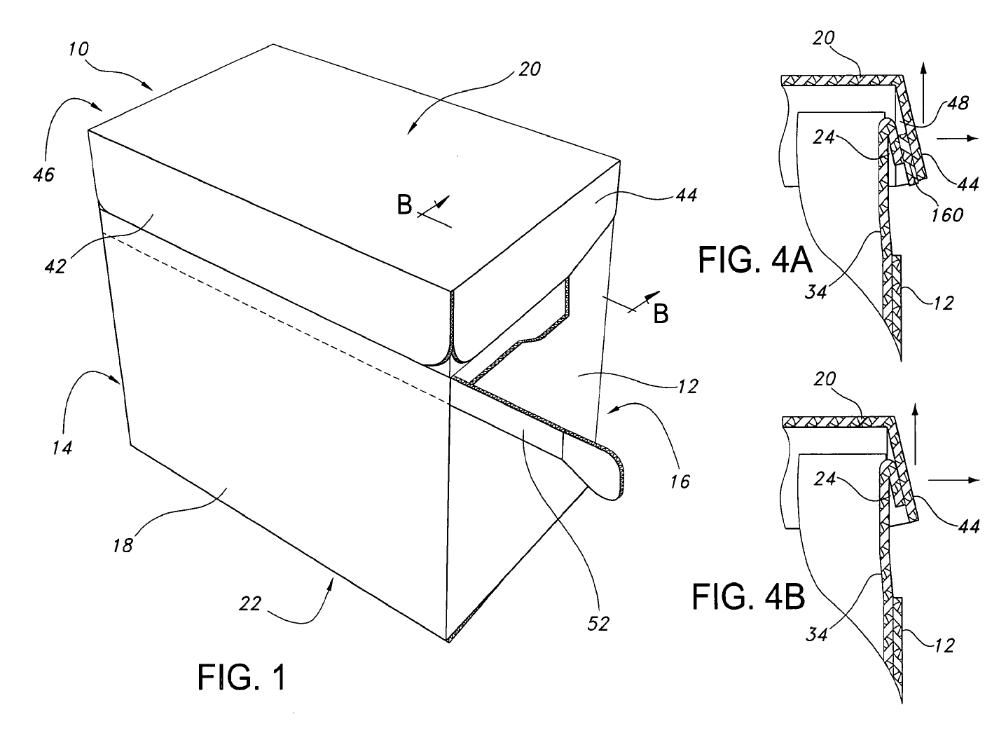

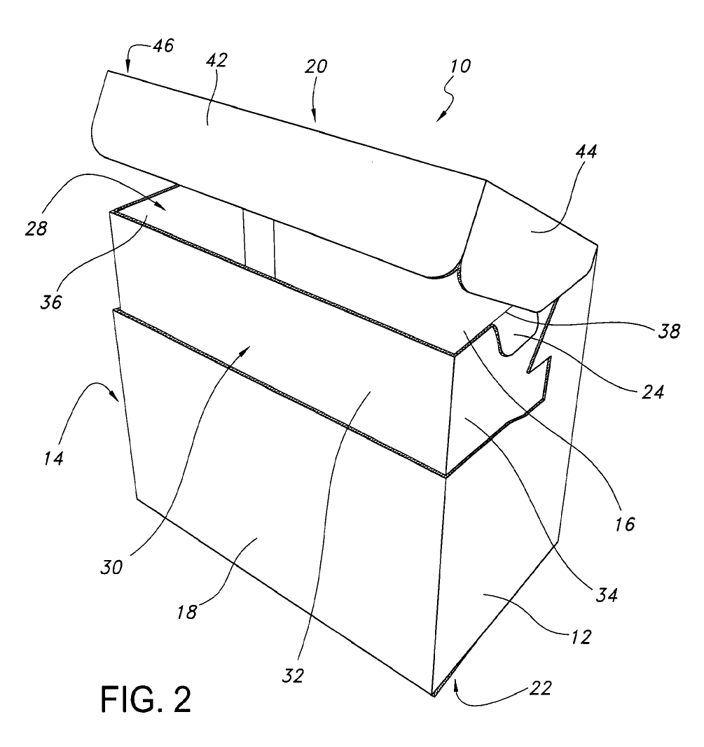

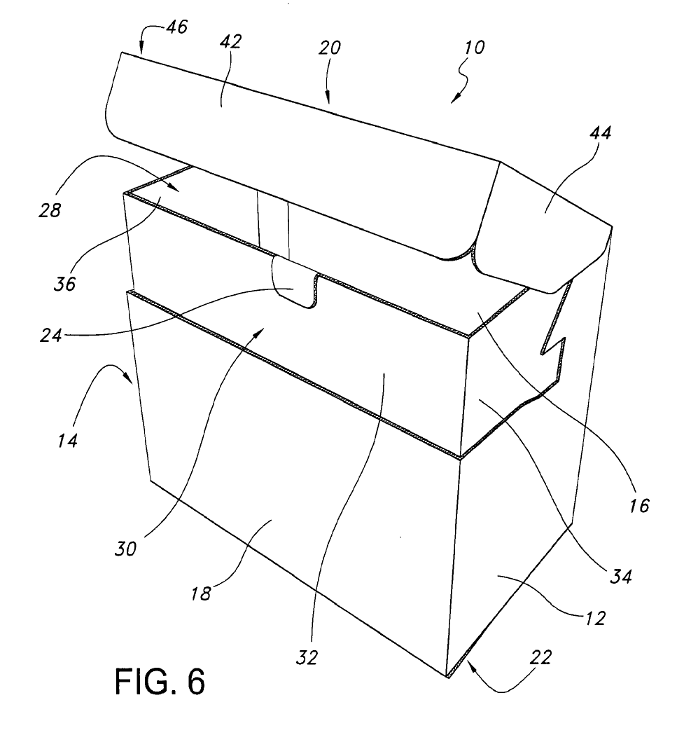

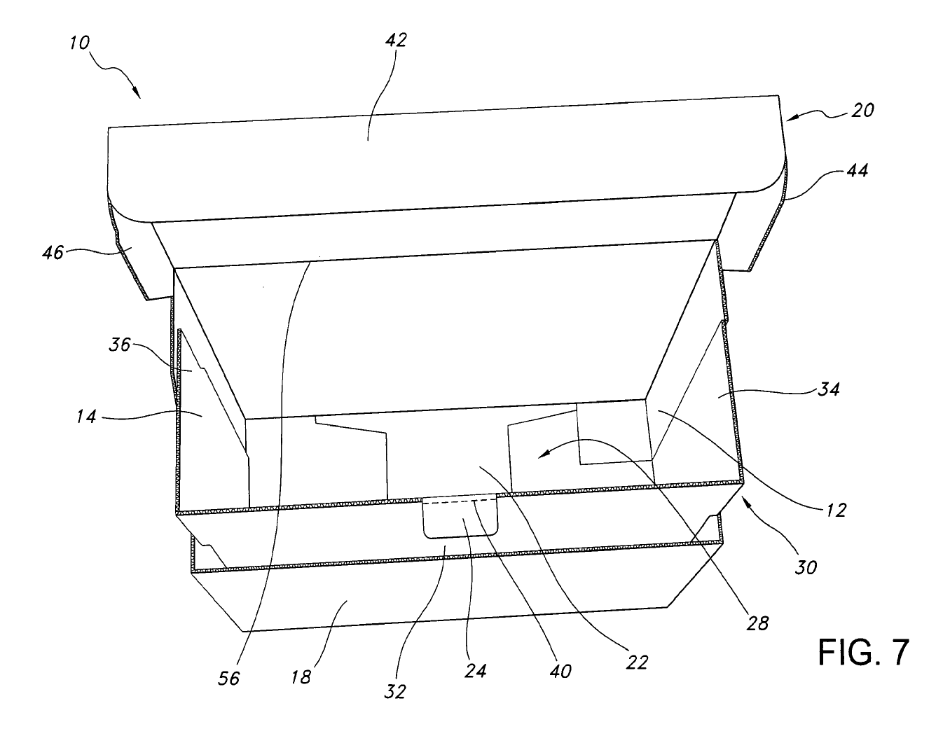

The various aspects of the invention may be embodied in various forms. The following description shows by way of illustration various embodiments in which aspects of the invention may be practiced. It is to be understood that other embodiments may be utilized and structural and functional modifications may be made without departing from the scope of the present invention. Referring now to FIGS. 1-4, 6 and 7, a click-lock re-closable carton 10 according to an embodiment of the invention is shown. As shown, carton 10 generally includes a pair of opposing side panels 12 and 14, a back panel 16, a front panel 18, a cover 20, a bottom 22, and locking tabs 24. The panels 12, 14, 16 and 18 together with cover 20 and bottom 22 form a generally cubic hollow cavity 28.

Adhered to the inside of front panel 18 and side panels 12 and 14 is an inner liner or sleeve 30. Sleeve 30 includes a front pane 32 and side panes 34 and 36 respectively attached to opposing ones of panels 18, 12 and 14. Sleeve 30 generally seals the carton in a closed configuration by reducing air and moisture flow through the gap between cover 20 and panels 12, 14 and 18. As shown in FIGS. 1, 4, 6 and 7, cover 20 includes a front flange 42 and a pair of opposing side flanges 44 and 46. The inside of flanges 42, 44 and 46 respectively oppose and overlie outside upper portions of panes 32, 34 and 36 in the closed configuration.

This overlapping fit of flanges 42, 44 and 46 with panes 32, 34 and 36 retain cover 20 in a closed position. The overlapping fit alone, however, often does not securely retain cover 20 in a fully closed configuration. In addition, overlapping alone does not prevent cover 20 from popping up, such as when the carton is inadvertently bumped upward. Further, if a user closes a cover on a carton that merely relies on overlapping to retain the cover, the user does not receive any indication that the cover is fully closed. For example, the user does not feel or hear any indication that he or she fully closed the cover.

To more fully retain cover 20 in a closed configuration, locking tabs 24 may be used. Locking tabs 24 are each respectively attached to either one of side panes 34 and 36 of sleeve 30 by a fold line 38 or to front pane 32 by a fold line 40. Locking tabs 24 located on the sides of carton 10 retain cover 20 by engaging flanges 44 and 46 while locking tab 24 located on the front of carton 10 retains cover 20 by engaging flange 42. As shown in FIG. 4A, flanges 42, 44 and 46 each preferably include a locking recess 48 to respectively mate with locking tabs 24 when cover 20 is fully closed. Locking recesses 48 preferably are generally inverse replicas of locking tabs 24. For instance, locking recesses 48 may be generally u-shaped recesses that match the u-shaped outline of locking tabs 24. When locking recesses 48 engage locking tabs 24, they retain cover 20 from moving in the upward direction. Because of their matching u-shape, locking recesses 48 engage locking tabs 24 along their mating bottom and side edges, which firmly retains cover 20 in the closed configuration. Other configurations are contemplated, such as a lip (not shown) along the inside of flanges 42, 44 and 46 to engage the lower edge of locking tabs 24 in a closed configuration, as well as other shapes, such as generally v-shaped locking tabs. Flanges 42, 44 and 46 preferably include a double board thickness to define locking recesses 48 while providing an uninterrupted outer surface. In an alternate embodiment, shown in FIG. 4B, locking tabs 24 may retain cover 20 via a force fit from outwardly biased locking tabs 24 frictionally engaging flanges 42, 44 and/or 46.

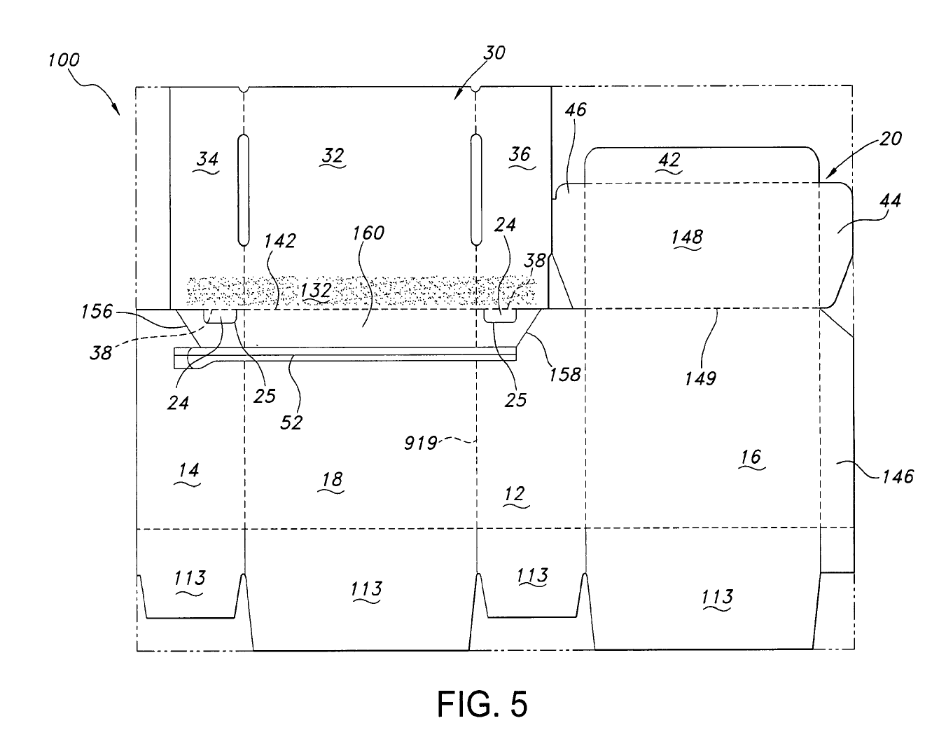

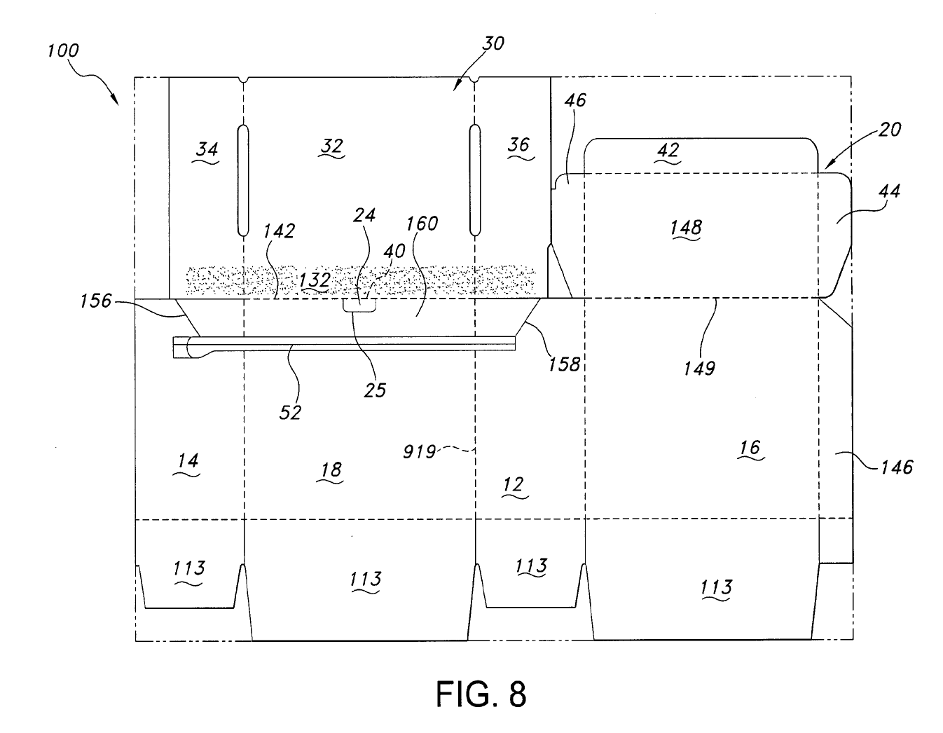

Click-lock carton 10 may be opened by removing a tear strip 52 disposed within side panels 12 and 14 and across front panel 18. This permits cover 20 to pivot from back panel 16 for opening and closing. In the preferred embodiment, when initially opened, locking tabs 24 tear apart from locking recesses 48 along the perforation line disposed therebetween (see cut lines 25 of FIGS. 5 and 8, which are discussed below). When re-closed, locking tabs 24 engage respective locking recesses 48 to retain cover 20 in a closed position. As mentioned above, the u-shaped design of locking recesses 48 provides sturdy retention of cover 20 by retaining it in three directions. There is sufficient flex in the carton so that cover 20 can be easily opened by simply pulling upward on cover 20.

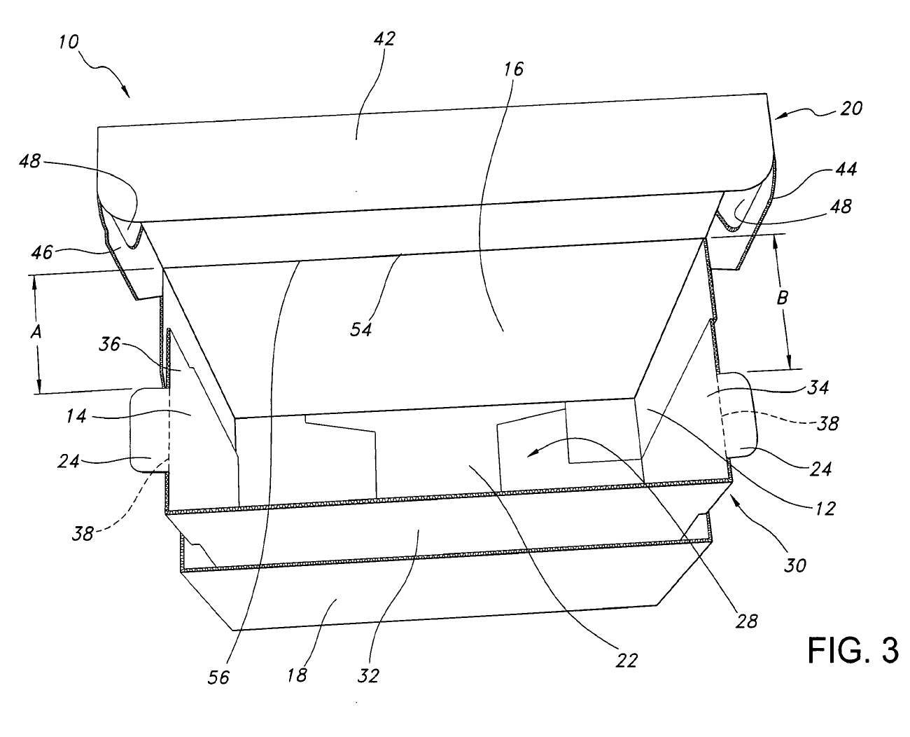

To further improve retention of cover 20 in a closed configuration, locking tabs 24 located on side panels 12 and 14 are preferably offset from one another. For example, as shown in FIG. 3, locking tab 24 on side panel 14 is disposed a distance A from back panel 16, and locking tab 24 on opposite side panel 12 is disposed a longer distance B from the back panel 16. Thus, locking tab 24 on one side of carbon 10 is disposed a greater distance from the pivot axis 56 of cover 20 along fold line 54 where it mates with back panel 16 than the other locking tab 24 on the other side. As such, locking tabs 24 each retain cover 20 at different rotation-arm distances along cover 20, which can help to ensure that cover 20 is securely retained in the closed configuration.

For example, when a user closes cover 20 by rotating it from a generally vertical position to a generally horizontal position, each of the locking tabs 24 engages cover 20 at different times. For instance, locking tab 24 on side panel 14 is disposed closer to fold line 56 and will engage respective locking recess 48 on flange 46 prior to locking tab 24 on side panel 12 engaging its respective locking recess 48 on flange 44. Thus, if the user does not completely close cover 20, locking tab 24 on side panel 14, which is disposed closer to fold line 54 may still engage cover 20 to keep it generally closed. Because locking tabs 24 are foldably attached to sleeve panes 34 and 36 and are generally biased outward, they engage locking recesses 48 with a clicking action. When they click into place, they may provide a clicking sound and the user may feel the clicking action. Thus, the user may easily recognize when cover 20 is in a closed configuration. With locking tabs 24 offset from one another, the user may further easily recognize two distinct clicks as one tab is engaged prior to the other.

Carton 10 may be formed from a unitary carton blank, such as unitary blank 100 shown in FIGS. 5 and 8, which is discussed further below. Unitary blank 100 generally includes a unitary corrugated paperboard blank that is suitably cut, scored, perforated, etc. to be folded into carton 10. It is understood that other suitable materials, such as corrugated plastic, may also be used for these blanks. As discussed further below with respect to FIG. 5, to form carton 10, sleeve 30 and cover 20 are folded 180 degrees about fold lines 142 and 149 respectively. Next, unitary blank 100 is folded 180 degrees about fold line 919 so an attachment tab 146 is adjacent to and may be attached to side panel 14 via suitable means, such as an adhesive or metal stitches (not shown). In this configuration, a flattened carton (not shown) may be formed. The flattened carton (not shown) occupies minimal space and is particularly suited for shipping bundles of cartons. Carton 10 may be formed by unfolding the flattened carton (not shown) to form a hollow rectangular body and then forming cover 20 and bottom 22.

Referring now to FIGS. 5 and 8, a unitary blank 100 is shown according to further embodiments of the invention. Unitary blank 100 is a uniform sheet of solid fiberboard or paperboard, corrugated fiberboard, solid or corrugated plastic board, or the like. Unitary blank 100 may be folded and assembled to a form a click-lock carton, such as click-lock carton 10. As shown, unitary blank 100 includes a front panel 18, a back panel 16, a left panel 14, a right panel 12, lower flaps 113 attached to the panels, a sleeve 30 and cover 20. The panels, flaps, sleeve and cover are formed from a sheet of substrate material, such as double-faced corrugated board, and connected as a single unit to form a carton. The preferred substrate material will be described hereinafter. The four panels 14, 18, 12 and 16 are serially connected to each other along their side portions. Each panel includes a lower flap 113 foldably connected at a lower portion, which forms the bottom 22 of the carton when assembled.

Sleeve 30 is foldably attached to upper portions of front panel 18 and side panels 12 and 14 of unitary blank 100. Sleeve 30 includes three panes 34, 32 and 36 serially connected to each other along fold lines. Along the fold line 142 between sleeve 30 and panels 18, 12 and 14, locking tabs 24 are foldably attached to side panes 34 and 36 of liner 30, as shown in FIG. 5. The locking tabs 24 are each formed in an upper portion of a respective side panel 12 and 14 of the carton body. In an alternative embodiment shown in FIG. 8, locking tab 24 is foldably attached to front pane 32 and is formed in an upper portion of front panel 18 of the carton body. Locking tabs 24 are respectively defined via cut lines 25, which may be complete cutouts or a perforated cut. Cut lines 25 also define locking recesses 48 in the assembled carton that engage locking tabs 24. Cut lines 25 are generally u-shaped, and thereby define locking tabs 24, as well as their respective locking recesses 48, as being generally u-shaped. U-shaped cut lines 25 extend from fold line 142 away from sleeve 30, and curve back to fold line 142 in a general u-shape. As such, locking tabs 24 are respectively connected to panes 32, 34 and 36 of sleeve 30 by fold lines 38. The remainder of the locking tabs 24 may be connected to panels 12, 14 and 18 along cut lines 25.

Unitary blank 100 provides a cost-effective blank for forming a click-lock carton. For example, unitary blank 100 is a compact design that has very little waste material. As shown in FIGS. 5 and 8, the blank material for forming sleeve 30 is disposed alongside the blank material for forming cover 20. Both of the liner 30 and cover 20 are connected to panels 12, 14, 16 and 18. As such, a generally rectangular blank is formed with very little unused blank material as evidenced by the minimal empty space located within the broken line surrounding unitary blank 100 in FIGS. 5 and 8, which represents the area of the starting material for forming blank 100. Reducing the amount of blank material used to form unitary blank 100 reduces the amount of substrate used, thereby reducing manufacturing costs.

In addition, the use of a unitary blank to form a carton reduces manufacturing costs associated with producing multiple blanks for each carton, and with assembling multiple blanks to form each carton. For example, cost savings are realized by reducing the number of components maintained, shipped, tracked and otherwise planned for in order to produce such cartons. Further, manufacturing is simplified by permitting an operator to assemble the carton from a single unitary blank without having to mate independent components.

Click-lock carton 10 is assembled by folding and adhering portions of blank 100 to other portions of the blank. To form the carton, liner 30 is folded 180 degrees along fold line 142 to place it in contact with a first side of the blank. Sleeve 30 is attached to opposing surfaces of panels 14, 18 and 12 via an adhesive, except in region 132 of sleeve 30 and the area of panels 14, 18 and 12 disposed between tear strip 52 and fold line 142. Generally cubic-shaped carton 10 is formed by attaching a securing flap 146 to side panel 14. Bottom flaps 113 are then folded and secured to form bottom 22 of carton 10 as shown in FIG. 1. Top flap 148 is folded along fold line 149 adjacent to back panel 16 to form cover 20.

Foldably attached along the periphery of top flap 148 are side flanges 42, 44 and 46, which are folded about ninety degrees to respectively form side flanges 42, 44 and 46 of carton 10. The inside surfaces of side flanges 42, 44 and 46 are glued to the outside of panels 14, 18 and 12 in the region 160 bounded by fold line 142, cut lines 25, tear strip 52, and cut lines 156 and 158. Region 160, along with side flanges 42, 44 and 46 of top flap 148, form the double-wall side flanges 42, 44 and 46 of carton 10. The double-wall thickness of these flanges permit locking recesses 48 to be formed while maintaining an uninterrupted outer surface, which seals moisture out of the carton in the closed configuration and provides a better appearance.

Unitary blank 100 preferably is made from a sheet of corrugated substrate material that includes a polymer moisture barrier extruded onto one or more layers of corrugated board material, such as fiberboard. The polymer moisture barrier may include a variety of polyolefins, such as polyester, polyethylene, PET or polypropylene. Different moisture barrier materials may provide different advantages. For instance, as discussed in connection with the embodiments described below, polyethylene can provide a good quality moisture barrier. On the other hand, PET provides a moisture barrier that can withstand the high temperatures used in corrugators better than other moisture barriers due to PET's high melting point. It is contemplated that a variety of substrate materials may be used to form unitary blank 100.

Preferably the polymer moisture barrier is high density polyethylene or a blend of high density polyethylene and low density polyethylene. It has been found that a blend of about 70% of a high density polyethylene, such as a polyethylene having a density of about 0.962 grams per cubic centimeter, and about 30% of a low density polyethylene, such as a polyethylene having a density of about 0.921 grams per cubic centimeter, extruded at a thickness of about 1.25 mils on a suitable substrate provides a particularly useful unitary blank with a low MVTR. The MVTR achieved with this invention is about 0.63 grams per meter squared in 24 hours as measured by a Mocon Permatran using ASTM standard E-389. Such a low MVTR is achieved without the need for other polymeric films adhered to the polyethylene blend or the use of other oriented films or polymers adhered to the substrate with an adhesive. Indeed, with the present invention, the functionality of prior art low MVTR barriers is achieved at lower expense and with fewer processing steps.

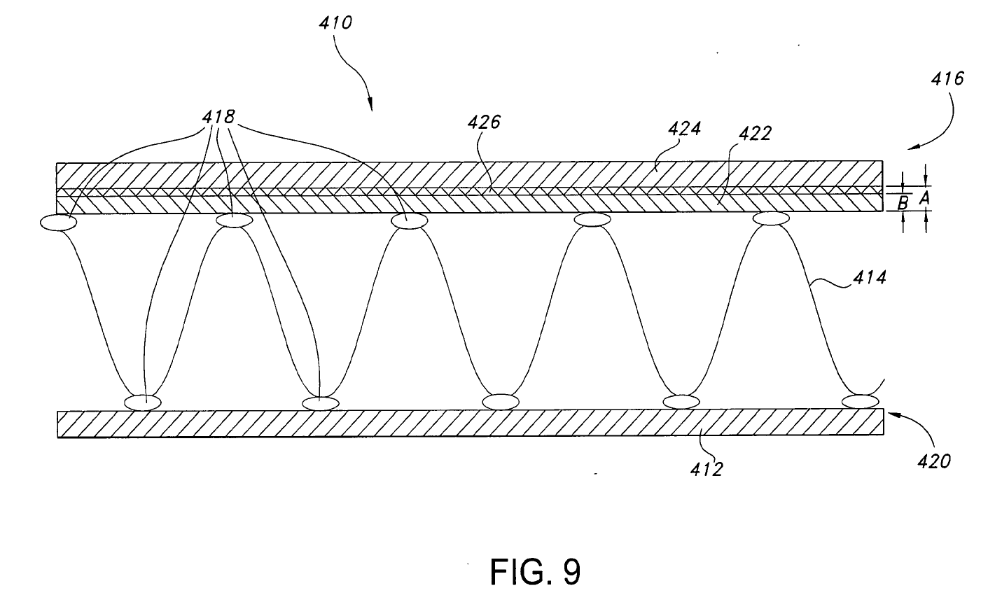

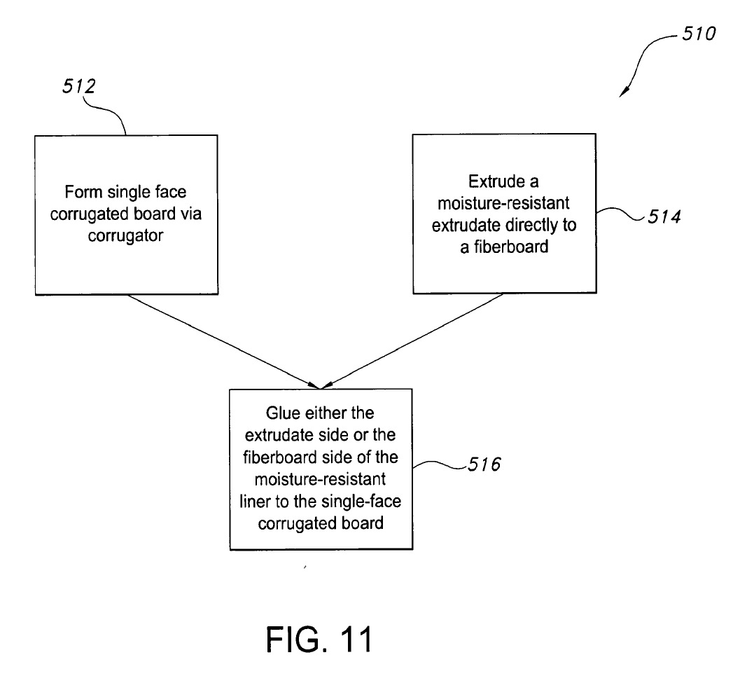

Referring now to FIGS. 9 and 11, a low MVTR corrugated board 410 is shown according to an embodiment of the invention. Corrugated board 410 may be used with blank 100 to form click-lock carton 10 as well as for a variety of other uses. Corrugated board 410 generally includes a first panel 412 bonded to microflute corrugate 414 at a first side and a second panel 416 attached to an opposite side of microflute corrugate 414. Such bond locations are denoted by reference number 418. Depending upon the material used for first panel 412 and second panel 416, either a starch bond or a cold set adhesive may be used to bond first panel 412 and second panel 416 to microflute corrugate 414. If desired, a starch bond can be used at one side and a cold set adhesive can be used at another side. A starch bond provides adequate adhesion at low cost and is typically used to bond the elements of a corrugated carton together in a standard corrugator, which typically operates at temperatures in the range of 200 degrees Fahrenheit up to about 380 degrees Fahrenheit. A cold set adhesive provides adhesion without the need for the heat of a typical corrugator, but is more expensive than the use of a starch bond. Where polyethylene is the moisture barrier, a cold set adhesive should be used because of the relatively low melting point of the polyethylene as compared to the heat of a standard corrugator. On the other hand, where PET is the moisture barrier, a standard starch bond may be used in a standard corrugator because PET has a higher melt point than the temperatures at which standard corrugators operate.

First panel 412 and microflute 414 are preferably formed as a single face corrugated board 420, which is manufactured using a corrugator as is known in the art. Where polyethylene is used for the moisture barrier, the second panel 416, which includes polyethylene 422 extruded onto the surface of fiberboard liner 424, is preferably cold laminated to the flute tips of single face corrugated board 420. As shown in FIG. 9, an impregnated zone 426 of second panel 416 includes a mechanical combination of polymer 422 and fiberboard liner 424. A generally homogenous polymer layer 422 exists that further resists the transmission of moisture vapor and has a total thickness A of about 1.25 mils. The thickness B of polymer extending from the surface of fiberboard liner 424 is about 1.10 mils.

Low MVTR corrugated board 410 provides a corrugated board having good moisture barrier properties with relatively high compression strength. For instance, a laundry detergent carton according to the embodiment of carton 10 shown in FIG. 1 that uses corrugated board 410 has good strength properties and moisture-resistance properties without the use of a separate structural liner insert. The use of a single board saves material costs and manufacturing costs, and reduces carton mass in comparison with a similar design using a structural liner insert that lines four walls of the carton.

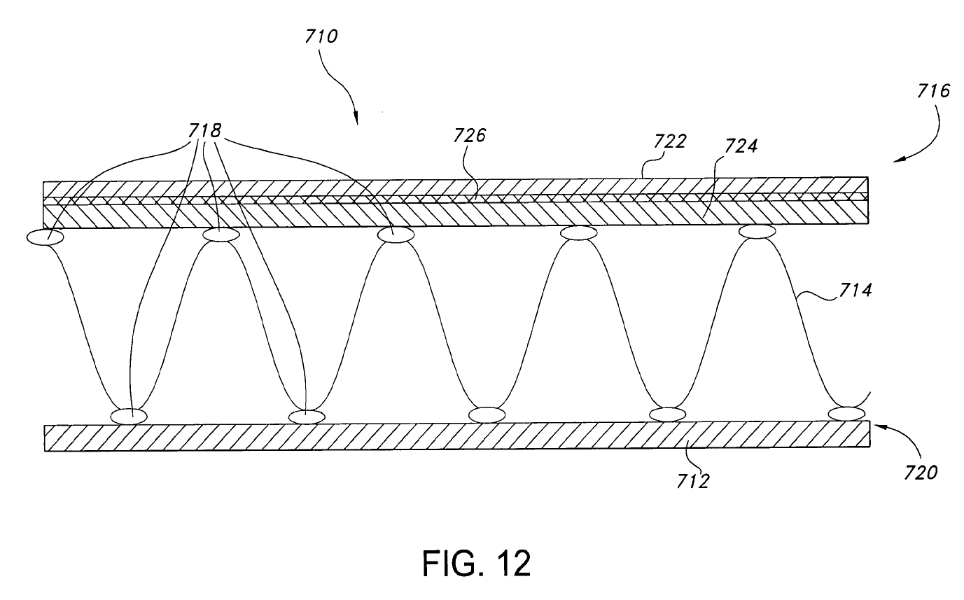

Polymer 422 is directly extruded to fiberboard liner 424 without the use of a binding agent. Directly extruding polymer 422 to fiberboard liner 424 permits polymer 422 to at least partially penetrate fiberboard liner 424. As such, a relatively strong mechanical bond is formed between polymer 422 and fiberboard liner 424 without the use of binding agents. This reduces material costs and manufacturing costs related to forming corrugated board 410. As shown in FIG. 9, polymer 422 is preferably set against microflute layer 414, but could be on the exterior if desired. See FIG. 12.

The process of forming second panel 416 may include flame treating fiberboard liner 424 to improve its ability to absorb molten polymer, and coating fiberboard liner 424 with extruded molten polymer. The extrusion process may include heating, melting, and extruding the polymer using, for example, a screw-driven extruder, to coat fiberboard liner 424. The production rate, temperature of the molten polymer, and other parameters are preferably controlled to permit a desired amount of polymer to impregnate fiberboard 424.

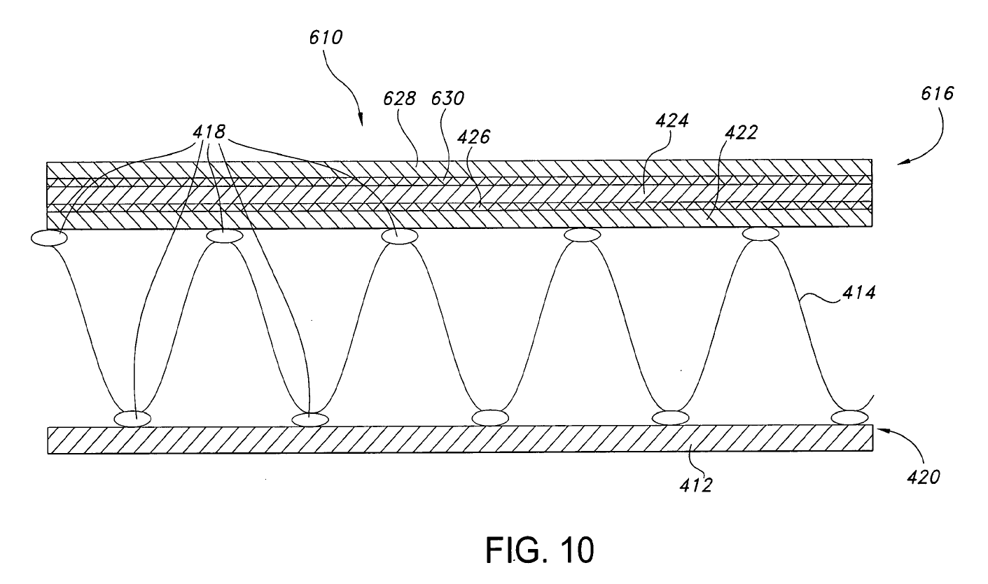

Second panel 416 may be printed independently of the process for assembling the double face corrugated board 410. Printing the non-coated side of fiberboard liner 424 after the extrusion process reduces the possibility of adversely affecting the quality of the printed surface; although, fiberboard liner 424 may be printed prior to extrusion. Preferably, where a high quality printable fiberboard liner 424, such as 12 point solid bleach sulfate, is used printing can be applied to the exterior surface of fiberboard liner 424 in the embodiment of corrugate board 410 of FIG. 9. Cold lamination of the second panel 416 to single-face corrugated board 420 using a cold set adhesive further reduces the possibility of affecting the quality of the printed surface. If printing is desired on the moisture barrier side of the fiberboard liner, printing can occur after the application of polymer, which avoids the use of primers while providing a printed surface on the polymer side. See FIGS. 10 and 12. Both of these methods allows for good penetration of the extrudate into the fiberboard liner without a primer affecting such penetration.

FIG. 11 is a flowchart 510 that illustrates a method for forming corrugated board 410 according to an embodiment of the invention. As shown, the method includes step 512 of forming a single face corrugated board 420 via a corrugator, and step 514 of extruding a moisture-resistant extrudate 422 directly to a fiberboard 424 for forming a moisture-resistant liner 416. As an example, about 12 pounds to about 22 pounds of polyethylene resin may be applied to about every 1,000 to 3,000 square feet of fiberboard 424. Preferably about 14.4 pounds per thousand square feet are used. Steps 512 and 514 can be performed in any order. Subsequent to steps 512 and 514, the method includes step 516 of gluing either the extrudate side or the fiberboard side of the moisture-resistant liner 416 to the single-faced corrugated board 420.

Referring now to FIG. 10, a low MVTR corrugated board 610 is shown according to another embodiment of the invention. Corrugated board 610 may be used with blank 100 and to form click-lock carton 10, as well as for a variety of other uses. Corrugated board 610 generally includes the same aspects and preferences as corrugated board 410, except that second panel 616 includes a second layer of polymer extrudate 628 on the opposite side from the first layer of polymer extrudate 422. The second layer of polymer extrudate 628 generally includes the same aspects and preferences as the first layer discussed with corrugated board 410, and is generally extruded directly onto the surface of fiberboard liner 424. A second impregnated zone 630 of second panel 616 includes a mechanical combination of polymer extrudate 628 and fiberboard liner 424.

Applying second layer of polymer extrudate 628 provides additional moisture barrier performance and may increase the appearance and gloss values due to printing on the polymer extrudate 628. For example, for use with extremely moisture sensitive products or in extremely humid environments, it may desirable to have a moisture barrier on the exterior face of the corrugated board 610, and a reinforcing moisture barrier integral to the corrugated board disposed adjacent to the microflute. This can provide robust moisture protection to the microflute material 414, which preserves its structural strength, as well as to the contents of any carton formed from corrugated board 610. In addition, the second moisture-resistant extrudate may have different properties from the first extrudate as desired. For instance, the non-visible extrudate disposed within the finished corrugated board may have higher moisture-resistance properties than the second extrudate, and the second extrudate may have higher gloss or other appearance related properties than the first extrudate.

Referring now to FIGS. 12-14, a low MVTR corrugated board 710 is shown according to another embodiment of the invention. In this embodiment, corrugated board 710 generally has the same aspects and preferences as boards 510 and 610, except that the extrudate 722 is located on the outside of the fiberboard liner 724 with an impregnated zone 726. In this embodiment, polyester may be used to form the extrudate and both liners are bonded to the microflute. As discussed above in connection with the embodiment of FIG. 9, depending on the melting point of the polymer used as the moisture barrier, either a starch bond or a cold set adhesive may be used to bond the microflute 714 to the fiberboard liners 712 and 716. Corrugated board 710 may be used with blank 100 to form click-lock carton 10 as well as for various other uses. Corrugated board 710 generally includes a first panel 712 and a second panel 716 bonded to opposite sides of microflute corrugate 734. Microflute 714 and panels 712 and 716 are preferably formed as a double faced corrugated board 720 manufactured using a corrugator 812. Second panel 716 generally includes a polyolefin moisture barrier 722 thermally bonded at 718 to a fiberboard liner 724 via an extrusion lamination process.

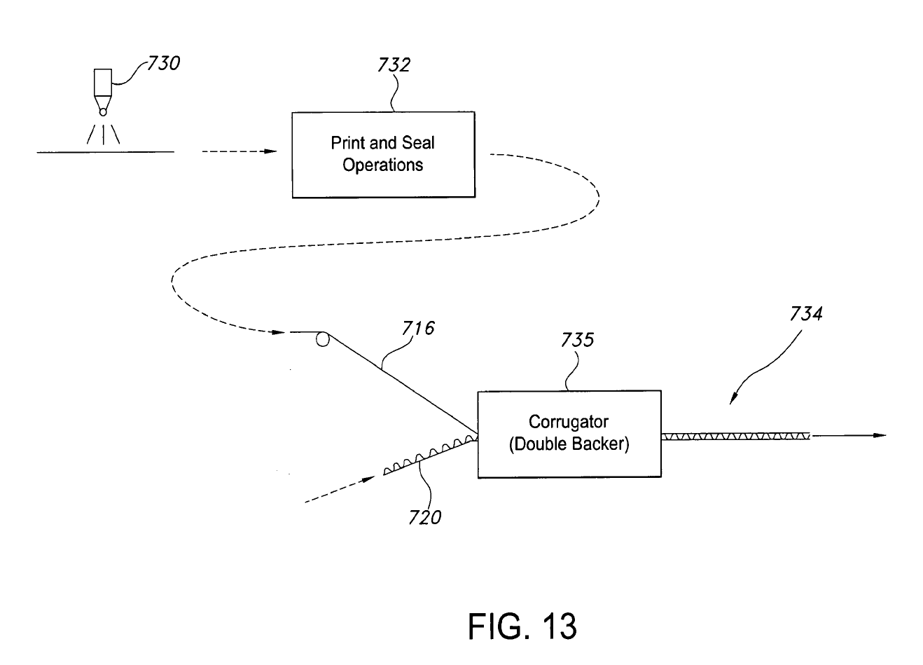

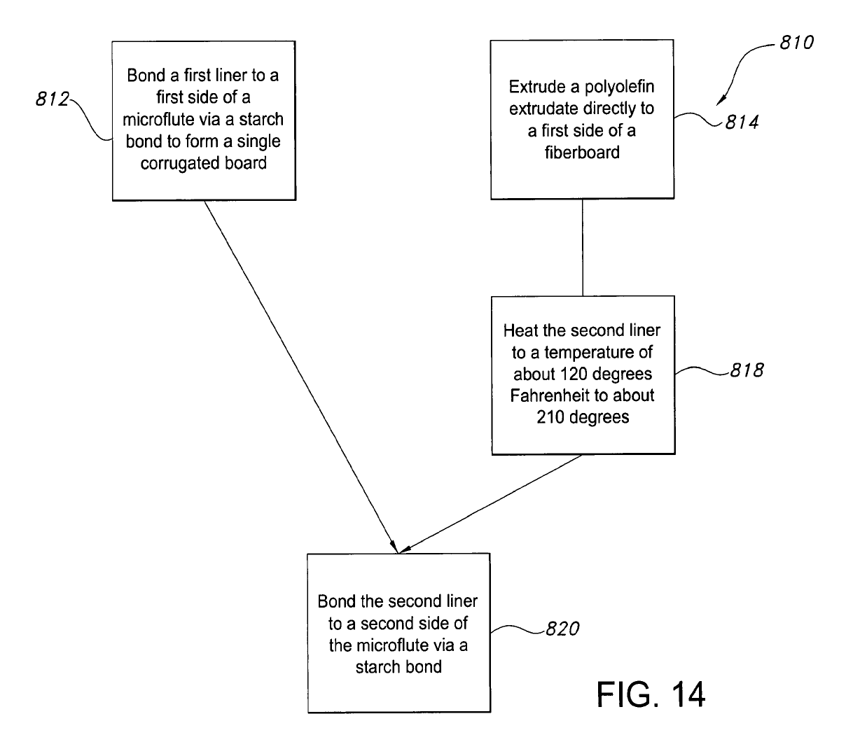

FIGS. 13 and 14 generally illustrate a method 810 for forming corrugated board 710 according to an embodiment of the invention. In step 812, a single face corrugated board 716 is formed by bonding a first liner 712 to a first side of microflute 714. In step 814, a second liner is formed by passing a fiberboard liner 724 through an extruder 730 to extrude a polyolefin extrudate 722 to a first side of fiberboard liner 724. As an example, heated PET resin is extruded at a thickness of about 1 mil directly to fiberboard liner 724 without the use of a binding agent. As with boards 410 and 610, PET resin penetrates fiberboard liner 724 to form a mechanical bond at impregnated zone 726 with the fiberboard. The bonded sheet 716 may subsequently be printed and sealed if desired via printing and sealing operations 732. As with boards 410 and 610, printing on top of the PET resin may avoid the use of a primer.

Bonded sheet 716 is subsequently passed through the double backer portion 735 of a corrugator 734 along with single face corrugated board 720 to form a double faced corrugated substrate using conventional techniques. As bonded sheet 716 is passed through corrugator 734, in steps 818 and 820 of method 810, it is heated to a temperature of about 120 degrees Fahrenheit up to about 210 degrees Fahrenheit, and bonded to single faced corrugated board 720 via a starch bond.

As noted above, corrugators generally operate in the temperature range of 200 degrees Fahrenheit up to about 380 degrees Fahrenheit. PET resins typically have melt points above this range, and for moisture-barrier applications of corrugated boards, preferably have a melt point of about 420 degrees Fahrenheit. As such, the printed layer of PET in the carton liner withstands corrugator processing better than other known barrier materials, such as polyethylene and polypropylene. Thus, scuffing and marring of the printed surface, as well as deformities in the moisture barrier layer in general, may be avoided through the use of PET resins as a moisture barrier when using corrugator processing. In addition, PET has better strength characteristics than many other barrier materials, such as polyethylene and polypropylene.

While the present invention has been described in connection with the illustrated embodiments, it will be appreciated and understood that modifications may be made without departing from the true spirit and scope of the invention. In particular, the invention applies to many different cartons of various shapes, designs and applications. Additionally, it is contemplated that various moisture barriers and corrugated board configurations applicable beyond the disclosed embodiments.

We claim:

1. A re-closable carton comprising:
a pair of opposing side panels;
a back panel joined along opposite sides to the side panels;
a cover pivotally attached to the back panel and having a pair of opposing side flanges, each side flange including a locking recess;
a first locking tab foldably attached to a top portion of a first one of the opposing side panels for engaging a first one of the locking recesses when the cover is in a closed configuration, the first locking tab being disposed at a first dimension from the back panel; and
a second locking tab foldably attached to a top portion of a second one of the opposing side panels for engaging a first one of the locking recesses when the cover is in a closed configuration, the second locking tab being disposed at a second dimension from the back panel, the second dimension being greater than the first dimension;
wherein the carton is formed from corrugated board having a first board, a microflute board having a first side and a second side, the microflute board attached at its first side to the first board via a starch bond; and a second board with a fiberboard substrate attached to the second side of the microflute board with a cold set adhesive, the fiberboard substrate having a first side and an opposite second side, and a moisture-resistant extrudate including high density polyethylene therein partially absorbed into the first side of the fiberboard substrate.

2. The carton blank of claim 1 wherein the moisture-resistant extrudate is comprised of a blend of high density polyethylene and low density polyethylene.

3. The carton of claim 2 wherein the moisture-resistant extrudate is comprised of a blend of about 70% high density polyethylene and about 30% low density polyethylene.

4. The carton of claim 3 wherein the moisture-resistant extrudate extends about 1.10 mils from an outer surface of first side of the fiberboard substrate.

5. A method for forming a low moisture vapor transmission rate corrugated board having only a moisture-resistant extrudate acting as the moisture vapor barrier comprising:
attaching a first fiberboard liner to a microflute at a first side of the microflute;
extruding a moisture-resistant extrudate including high density polyethylene directly to a second fiberboard liner without any intermediate composition to bind the moisture-resistant extrudate to the second fiberboard liner; and
adhering one of the extrudate and the second fiberboard liner to the microflute at a second side of the microflute with a cold set adhesive.

6. The carton blank of claim 5 wherein the moisture-resistant extrudate is comprised of a blend of high density polyethylene and low density polyethylene.

7. The carton of claim 6 wherein the moisture-resistant extrudate is comprised of a blend of about 70% high density polyethylene and about 30% low density polyethylene.

8. The carton of claim 7 wherein the moisture-resistant extrudate extends about 1.10 mils from an outer surface of first side of the fiberboard substrate.

9. A corrugated board consisting essentially of:
a first board;
a microflute board having a first side and a second side, the microflute board attached at its first side to the first board;
a second board formed from a fiberboard substrate having a first side and an opposite second side wherein the fiberboard substrate is attached to the microflute board; and
a moisture-resistant extrudate including high density polyethylene therein partially absorbed into the first side of the fiberboard substrate.

10. The carton blank of claim 9 wherein the moisture-resistant extrudate includes a blend of high density polyethylene and low density polyethylene.

11. The carton of claim 10 wherein the moisture-resistant extrudate includes a blend of about 70% high density polyethylene and about 30% low density polyethylene.

12. The carton of claim 11 wherein the moisture-resistant extrudate extends about 1.10 mils from an outer surface of first side of the fiberboard substrate.

13. A re-closable carton comprising:
a pair of opposing side panels;
a front panel joined along opposite sides to each of the opposing side panels;
a back panel joined along opposite sides to each of the opposing side panels;
a cover pivotally attached to the back panel and having a pair of opposing side flanges and a front flange;
a locking tab foldably attached to a top portion of at least one of the opposing side panels or front panel for engaging one of the opposing side flanges or front flange when the cover is in a closed configuration; and
wherein the carton is formed from corrugated board having a first board, a microflute board having a first side and a second side, the microflute board attached at its first side to the first board; and a second board formed from a fiberboard substrate attached to the second side of the microflute board, the fiberboard substrate having a first side and an opposite second side, and a moisture-resistant extrudate partially absorbed into the first side of the fiberboard substrate.

14. The carton blank of claim 13, wherein the moisture-resistant extrudate is comprised of polyethylene terephthalate.

15. The carton blank of claim 13, wherein the moisture-resistant extrudate is comprised of high density polyethylene.

16. The carton blank of claim 13 wherein the moisture-resistant extrudate is comprised of a blend of high density polyethylene and low density polyethylene.

17. The carton of claim 16 wherein the moisture-resistant extrudate is comprised of a blend of about 70% high density polyethylene and about 30% low density polyethylene.

18. The carton of claim 17 wherein the moisture-resistant extrudate extends about 1.10 mils from an outer surface of first side of the fiberboard substrate.
